(19) United States
(12) Patent Application Publication
(10) Pub. No.: US 2005/0092143 A1
(43) Pub. Date: May 5, 2005

(54) Position sensing electronic torque wrench

(76) Inventors: Mark W. Lehnert, Rochester Hills, MI (US); Thomas M. Jones, Brighton, MI (US); John M. Schiappacasse, Farmington Hills, MI (US)

Correspondence Address: YOUNG & BASILE, P.C., Suite 624, 3001 West Big Beaver Road, Troy, MI, 48084-3107, US

(21) Appl. No.: 10/903,577

(22) Filed: Jul. 30, 2004

Related U.S. Application Data
(60) Provisional application No. 60/491,088, filed on Jul. 30, 2003.

(51) Int. Cl. B25B 23/151

(52) U.S. Cl. 81/469

(57) ABSTRACT

The present invention provides a device for confirming that threaded fasteners have been tightened to the level of torque required by the assembly specification. An apparatus and method is provided for validating or verifying a fastener connection. A wrench or other torque tool can be engaged with a fastener to be tested. A rotation sensor is associated with the wrench for sensing rotation of the fastener and for generating a first output signal. A torque sensor is associated with the wrench for generating a second output signal corresponding to torque being generated by the wrench against the fastener. A processor is in communication with the rotation sensor to receive the first output signal and is in communication with the torque sensor to receive the second output signal. The processor analyzes the first and second output signals in accordance with a control program stored in memory.

### FIELD OF THE INVENTION

The present invention relates to an apparatus and method for validating a fastener connection by analyzing output signals from a rotation sensor and a torque sensor in accordance with a control program.

### BACKGROUND OF THE INVENTION

All assembly operations that incorporate threaded fasteners as clamping devices require that the amount of applied torque be controlled to some tolerance. A low torque condition may not provide enough friction to keep the fastener in place. Application of too much torque can cause an immediate or eventual failure of the fastener. In either case serious safety issues may exist. The most frequently used tools for torque process verification are the dial torque wrench and the click wrench. The dial torque wrench contains either a mechanically driven rotary dial or a strain gauge electronic circuit with a digital display. Although these systems may be very accurately calibrated, use of these tools is a subjective process. While using a dial torque wrench, the operator must engage the already tightened fastener and apply enough force to resume fastener rotation. The dial on the wrench will indicate the peak torque applied to the fastener during the test and not necessarily the actual torque that was applied by the process tooling. The final result is only as good as the operator's ability to sense rotation and then stop immediately. It is therefore possible to test a fastener that was within specification and cause an over torque condition. A click wrench uses a cam mechanism that reports an audible “Click” as the preset torque set point is exceeded. This test requires the operator to engage a previously tightened fastener and apply torque until the “Click” indicates that the residual torque on the fastener is greater than the set point defined by the process specification. The concern with this type of minimum torque test is that a dangerously high final torque will not be detected.

### SUMMARY OF THE INVENTION

Therefore, the present invention provides means for sensing fastener rotation during torque verification processes. The present invention can incorporate a solid state, single axis gyro circuit into a torque-testing wrench that can include at least one strain gauge, an instrumentation amplifier and a data collection microprocessor. Programming the “High” and “Low” limits are accomplished by data entry at the control panel on the tool. With a rotation signal available, data collection can be timed with actual movement of the fastener. The collected data can be compared against high and low torque limits two times during each test. The first compare can be executed as the fastener begins rotation. This torque value can be the actual break-away torque required to exceed the force applied by the assembly tooling. The resultant torque can be displayed on the readout panel of the tool. Lamps can indicate status such as a yellow lamp can indicate “Low”, a green lamp can indicate “Good” and a red lamp can indicate “High” torque. The second compare can be executed as the fastener stops rotating. This torque value can be the final test torque. The resultant torque can be displayed on the readout panel of the tool. Lamps can indicate status such as a yellow lamp can indicate “Low”, a green lamp can indicate “Good” and a red lamp can indicate “High” torque. The final test torque can be available to the operator. This can warn of a situation where the actual torque applied by the assembly tooling may have been within tolerance, while the test applied a final torque over the “High” limit.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a graph depicting a torque sensor output signal and a rotation sensor output signal versus time according to the present invention; and

FIG. 2 is a schematic diagram including a simplified electrical circuit according to the present invention.

### DESCRIPTION OF THE PREFERRED EMBODIMENT

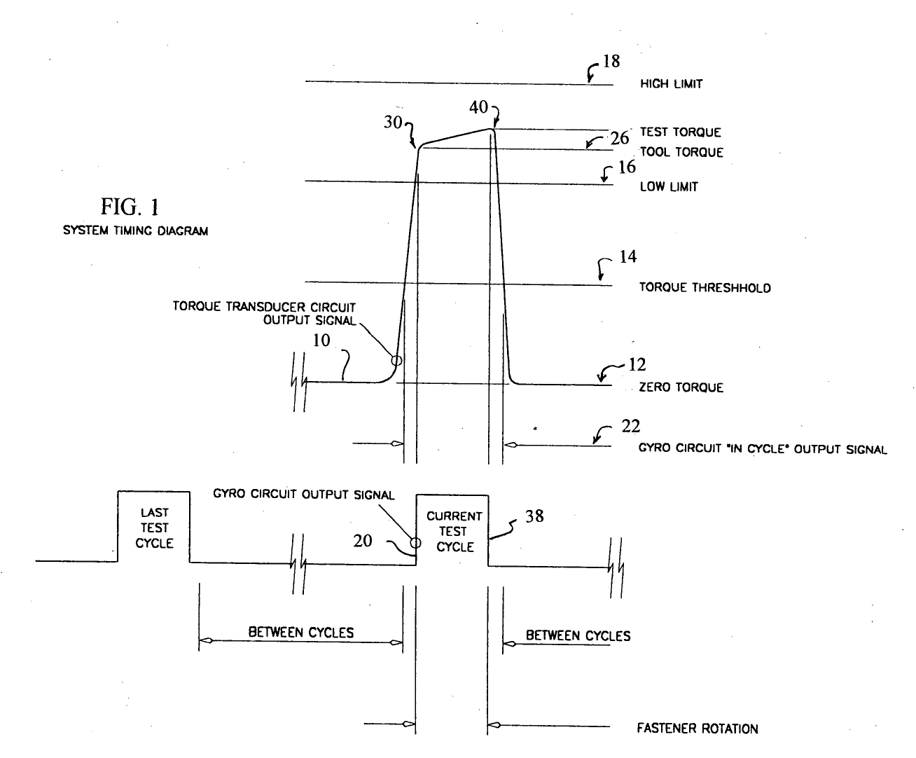

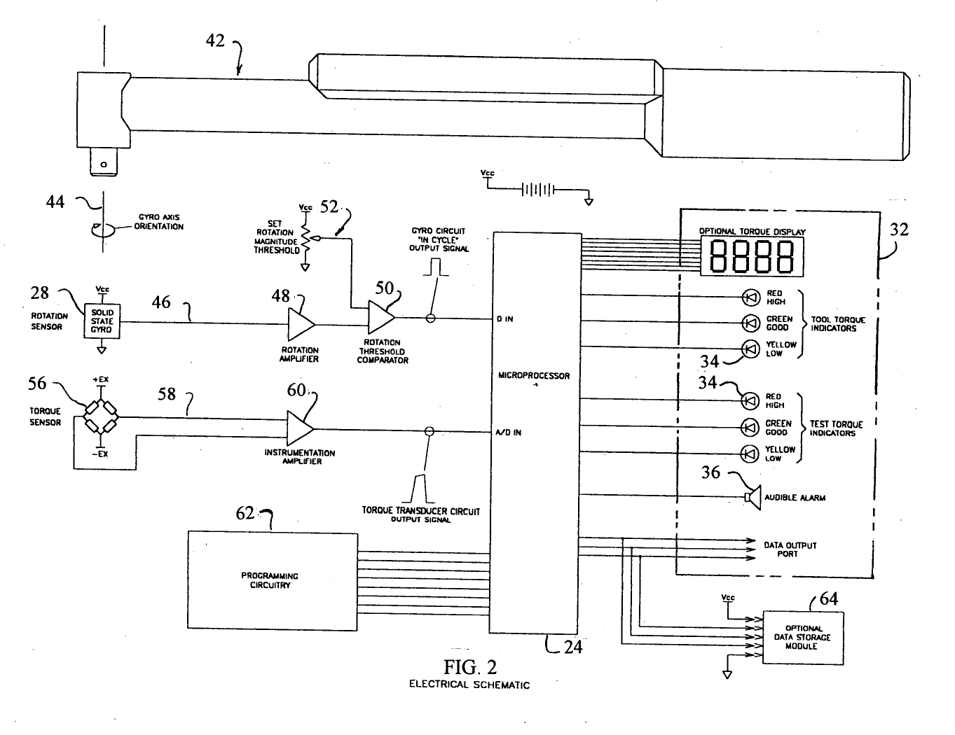

Referring to FIG. 1, a system timing diagram is illustrated beginning with the tool at rest, so that there is no torque signal 10 being generated by the torque sensors, such as by way of example and not limitation strain gauge sensors, as illustrated along horizontal zero torque line 12. A torque “Threshold” value shown as line 14 can be established by the microprocessor as a percentage of the “Low limit”. The operator can enter a “Low limit” of low torque limit value as illustrated along horizontal line 16 and “High limit” or high torque limit value as illustrated alone horizontal line 18. A test cycle 20 can be started when the operator engages a previously tightened fastener and applies additional tightening torque. The torque signal 10 rises rapidly through the “Torque threshold” value line 14 which activates the data collection portion or subroutine cycle 22 of the microprocessor 24 (seen in FIG. 2). As the increasing torque signal 10 reaches the residual torque value as illustrated by horizontal line 26, that was applied by the assembly tooling, the fastener begins to rotate. The fastener rotation can be sensed by the gyro or rotation sensor 28 (seen in FIG. 2), which can trigger or command the microprocessor to collect a rotation-initiated torque value as illustrated at point 30 for comparison with the “High” and “Low” torque limit values. A display panel 32 (seen in FIG. 2) can be provided with an appropriate display configuration. A plurality of lamps 34 can be provided in the display panel 32 for signaling the operator regarding the progress and results of the verification/validation process of the fastener connection or joint being tested. The appropriate lamp can be illuminated to inform the operator of various information regarding the test process. An audible alarm 36 can be provided to inform the operator that there has been rotation and that additional torque is not needed. The rotation-initiated torque value 30 can be available for the operator to monitor on the control panel of the tool. When rotation stops the gyro or rotation sensor 28 (seen in FIG. 2) can generate an output signal 38 to instruct the microprocessor to collect a second torque sample which is the final “Test torque” or final torque test value as illustrated at point 40. The final torque test value 40 can be compared with the “High ” and “Low” torque limit values. The final torque test value 40 can be available for the operator to monitor on the control panel of the tool. A second set of lamps 34 can be provided in the display panel 32 to visually indicate the final torque test value comparison results.

Referring now to FIG. 2, a schematic diagram including a simplified electrical circuit according to the present invention is illustrated. A rotatable tool or torque wrench 42 is schematically illustrated having an axis of rotation 44 operably associated with and monitored by the rotation sensor 28, by way of example and not limitation, such as a solid state gyro. The output signal 46 from the rotation sensor 28 can pass through a rotation signal amplifier 48 prior to entering a rotation threshold comparator 50. The rotation threshold comparator 50 compares the output signal 46 from the rotation sensor 28 with a preset rotation magnitude threshold value previously set by the operator. The rotation threshold comparator 50 generates a pulse output signal indicating the beginning of a test cycle with rotation of the fastener by the wrench or tool 42 and the end of the test cycle corresponding to ceased rotation of the fastener by the tool or wrench 42. In other words, the output signal 46 of the rotation sensor 28 can be conditioned and modified prior to being delivered to the processor 24 by way of example and not limitation, such as a microprocessor. A torque sensor 56 can be associated with the wrench or tool 42 for generating a second output signal 58 corresponding to torque being generated by the tool 42 against the fastener. The output signal 58 can pass through an instrumentation amplifier 60 prior to being delivered to the processor 24.

An apparatus according to the present invention can be used for validating or verification of a fastener connection. The apparatus can include a tool or wrench 42 engagable with a fastener to be tested. The rotation sensor 28 can be operably associated with the tool 42 for sensing rotation of the fastener and for generating a first output signal 46. The torque sensor 56 can be operably associated with the tool 42 for generating a second output signal 58 corresponding to torque being generated by the tool 42 against the fastener. A processor, by way of example and not limitation, such as a microprocessor 24, can be in communication with the rotation sensor 28 to receive the first output signal 46 and in communication with the torque sensor 56 to receive the second output signal 58. The processor 24 can be used for analyzing the first and second output signals 46, 58 in accordance with a control program 62. The control program 62 can monitor a torque reading or signal 58 from the torque sensor 56 until a value occurs greater than a threshold torque value 14 (seen in FIG. 1) triggers a data collection cycle or routine 22. The data collection routine of the control program 62 can direct the processor 24 to capture an initial-fastener-rotation torque value 30 from the torque sensor 56 in response to a rotation-initiated output signal 20 from the rotation sensor 28 when the fastener starts rotating. The data collection cycle or routine of the control program 62 can direct the processor 24 to capture a final-fastener-test torque value 40 (seen in FIG. 1) from the torque sensor 56 in response to a rotation-ceased output signal 38 from the rotation sensor 28 when the fastener stops rotating. The control program 62 can direct the processor to compare each of the first and second output signals and/or the initial-fastener-rotation torque value 30 and the final-fastener-test torque value 40 to a low torque limit value and a high torque limit value. A readout panel 32 can be provided for displaying results of the processor comparison of each of the first and second output signals and/or the initial-fastener-rotation torque value 30 and the final-fastener-test torque value 40 to the low torque limit value 16 (seen in FIG. 1) and the high torque limit value 18 (seen in FIG. 1). A plurality of lamps 34 can be provided in the display panel 32 for indicating status of the processor analysis for each of the first and second output signals, and/or the initial-fastener-rotation torque value 30 and the final-fastener-test torque value 40, such that a first lamp can indicate a torque reading lower than the low torque limit value 16, a second lamp can indicate a torque reading between the low torque value limit 16 and the high torque limit value 18, and a third lamp 34 can indicate a torque reading higher than the high torque limit value 18. By way of example and not limitation, the first lamp can be colored yellow, the second lamp can be colored green, and the third lamp can be colored red for easy operator identification as the test process progresses. The display panel 32 can include a control panel or data input/output port allowing the operator to set a low torque limit value, a high torque limit value, and a threshold torque value. The threshold torque value can be set as a calculated value determined from a percentage of the low torque limit value.

An apparatus according to the present invention can validate or verify a fastener connection using a torque wrench in combination with means for detecting motion of a fastener. The motion detecting means can be fully contained and devoid of any external reference hardware. The motion detecting means can be used for detecting at least one parameter selected from a group including movement of the fastener with respect to a reference starting position and a relative position of the fastener with respect to the reference starting position, and for generating a corresponding output signal. The motion detecting means according to the present invention can detect when a fastener initiates rotation. Processor means can be provided for capturing both an initial torque value at a moment of initial fastener rotation, and a final peak torque value when fastener rotation ceases. Additionally, the processor, in conjunction with the motion sensor, may process the data received and display an angle displacement value from selected program parameters including but not limited to either the point of initial fastener break away rotation, or from a threshold low torque value, to the point where fastener rotation ceases or to the point of peak captured torque. The apparatus according to the present invention can include a housing, and a battery enclosed within the housing for powering the motion detecting means. Signal conditioning means can be provided and enclosed within the housing for conditioning the output signal and digitizing collected data. A display can be provided for displaying torque readings and data, as well as torque limit values set by the operator. Storage means can be provided for storing collected data. Communication hardware and software can be provided for communicating through a network to an external device 64. The network can be selected from a group consisting of a wired local area network, a wired wide area network, a wireless local area network, a wireless wide area network, and any combination thereof. The external device can be selected from a group consisting of a personal digital assistant, a computer, a data collection device, a data storage device, and any combination thereof.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. An apparatus for validating a fastener connection comprising:
a wrench engagable with a fastener;
a rotation sensor connected to the wrench for sensing rotation of the fastener and for generating a first output signal;
a torque sensor connected to the wrench for generating a second output signal corresponding to torque being generated by the wrench against the fastener; and
a processor in communication with the rotation sensor to receive the first output signal and in communication with the torque sensor to receive the second output signal, the processor for analyzing the first and second output signals in accordance with a control program.

2. The apparatus of claim 1, wherein the control program monitors a torque reading from the torque sensor until a value greater than the threshold torque value triggers a data collection routine.

3. The apparatus of claim 2, wherein the data collection routine of the control program directs the processor to capture an initial-fastener-rotation torque value from the torque sensor in response to a rotation-initiated output signal from the rotation sensor when the fastener starts rotating.

4. The apparatus of claim 3, wherein the data collection routine of the control program directs the processor to compare the captured initial-fastener-rotation torque value with the low torque limit value and the high torque limit value.

5. The apparatus of claim 2, wherein the data collection routine of the control program directs the processor to capture a final-fastener-test torque value from the torque sensor in response to a rotation-ceased output signal from the rotation sensor when the fastener stops rotating.

6. The apparatus of claim 5, wherein the data collection routine of the control program directs the processor to compare the captured final-fastener-test torque value with the low torque limit value and the high torque limit value.

7. The apparatus of claim 1, wherein the control program directs the processor to compare each of the first and second output signals to a low torque limit value, and a high torque limit value.

8. The apparatus of claim 7 further comprising:
a readout panel for displaying results of the processor comparing each of the first and second output signals to the low torque limit value, and the high torque limit value.

9. The apparatus of claim 8 further comprising:
a plurality of lamps indicating status of the processor analysis for each of the first and second output signals, such that a first lamp indicates a torque reading lower than the low torque limit value, a second lamp indicates a torque reading between the low torque limit value and the high torque limit value, and a third lamp indicates a torque reading higher than the high torque limit value.

10. The apparatus of claim 9, wherein the first lamp is colored yellow, the second lamp is colored green, and the third lamp is colored red.

11. The apparatus of claim 1 further comprising:
a control panel for setting a low torque limit value, a high torque limit value, and a threshold torque value calculated as a percentage of the low torque limit value.

12. The apparatus of claim 1, wherein the processor is a microprocessor.

13. A process for validating a fastener connection comprising the steps of:
engaging a wrench with a fastener;
sensing rotation of the fastener with a rotation sensor connected to the wrench and generating a first output signal;
generating a second output signal corresponding to torque being generated by the wrench against the fastener with a torque sensor connected to the wrench;
receiving the first output signal from the rotation sensor and the second output signal from the torque sensor with a processor; and
analyzing the first and second output signals with the processor in accordance with a control program.

14. The process of claim 13, wherein the control program further comprises the step of
monitoring a torque reading from the torque sensor until a value greater than the threshold torque value triggers a data collection routine.

15. The process of claim 14, wherein the data collection routine of the control program further comprises the step of:
collecting an initial-fastener-rotation torque value from the torque sensor with the processor in response to a rotation-initiated output signal from the rotation sensor when the fastener starts rotating.

16. The process of claim 15, wherein the data collection routine of the control program further comprises the step of:
comparing the captured initial-fastener-rotation torque value with the low torque limit value and the high torque limit value with the processor.

17. The process of claim 14, wherein the data collection routine of the control program further comprises the step of:
collecting a final-fastener-test torque value from the torque sensor with the processor in response to a rotation-ceased output signal from the rotation sensor when the fastener stops rotating.

18. The process of claim 17, wherein the data collection routine of the control program further comprises the step of
comparing the captured initial-fastener-rotation torque value with the low torque limit value and the high torque limit value with the processor.

19. The process of claim 13, wherein the control program further comprises the step of:
comparing each of the first and second output signals to a low torque limit value, and a high torque limit value.

20. The process of claim 19 further comprising the step of:
displaying results of the processor comparing each of the first and second output signals to the low torque limit value, and the high torque limit value with a readout panel.

21. The process of claim 20 further comprising the step of:
indicating status of the processor analysis for each of the first and second output signals with a plurality of lamps, such that a first lamp indicates a torque reading lower than the low torque limit value, a second lamp indicates a torque reading between the low torque limit value and the high torque limit value, and a third lamp indicates a torque reading higher than the high torque limit value.

22. The process of claim 21, wherein the first lamp is colored yellow, the second lamp is colored green, and the third lamp is colored red.

23. The process of claim 13 further comprising the step of:
setting a low torque limit value, a high torque limit value, and a threshold torque value calculated as a percentage of the low torque limit value with a control panel.

24. The process of claim 13, wherein the processor is a microprocessor.

25. An apparatus for validating a fastener connection comprising:
a torque wrench; and
means for detecting motion of a fastener, the motion detecting means fully contained and devoid of any external reference hardware, the motion detecting means for detecting at least one parameter selected from a group including movement of the fastener with respect to a reference starting position and a relative position of the fastener with respect to the reference starting position and for generating a corresponding output signal.

26. The apparatus of claim 25 wherein the motion detecting means detects when a fastener initiates rotation, and further comprises processor means for capturing both an initial torque value at a moment of initial fastener rotation, and a final peak torque value when fastener rotation ceases.

27. The apparatus of claim 25 further comprising:
a housing;
a battery enclosed within the housing for powering the motion detecting means;
signal conditioning means enclosed within the housing for conditioning the output signal and digitizing collected data; and
a display for displaying torque readings and data, and torque limit values.

28. The apparatus of claim 25 further comprising:
storage means for storing collected data; and
communication hardware and software for communicating through a network to an external device.

29. The apparatus of claim 28 further comprising:
the network selected from a group consisting of a wired local area network, a wired wide area network, a wireless local area network, a wireless wide area network, and any combination thereof.

30. The apparatus of claim 28 further comprising:
the external device selected from a group consisting of a personal digital assistant, a computer, a data collection device, a data storage device, and any combination thereof.
